(19) United States
(12) Patent Application Publication
(10) Pub. No.: US 2005/0043850 A1
(43) Pub. Date: Feb. 24, 2005

(54) Tote-based warehousing system and method

(76) Inventors: John Stevens, Stratham, NH (US); Paul Waterhouse, Toronto (CA); Mike Vandenberg, Toronto (CA)

Correspondence Address: MCGINN & GIBB, PLLC, 8321 OLD COURTHOUSE ROAD, SUITE 200, VIENNA, VA, 22182-3817, US

(21) Appl. No.: 10/474,353

(22) PCT Filed: Apr. 9, 2002
(86) PCT No.: PCT/US02/10927

Related U.S. Application Data
(60) Provisional application No. 60/282,150, filed on Apr. 9, 2001.
(60) Provisional application No. 60/359,350, filed on Feb. 26, 2002.

(51) Int. Cl. G06F 7/00

(52) U.S. Cl. 700/213

(57) ABSTRACT

A warehousing system includes a container (e.g., tote) for storing at least one item of merchandise, a first electronic (e.g,. radio frequency identification (RFID)) module associated with the first container, and a controller which wirelessly communicates with first electronic module, for directing a transfer of said at least one item of merchandise to and/or from said first container. The inventive system may include, for example, a hybrid retail/warehouse system which includes a facility having a shelving area, and a picking area adjacent to the shelving area, and a layout so as to minimize a picking area and a walking distance between a picking area and a shelving area.

### CROSS REFERENCE TO RELATED APPLICATIONS

This Application claims the benefit of U.S. Provisional Application No. 60/282,150 which was filed on Apr. 9, 2001 by John Stevens, and assigned to the present assignee, and U.S. Provisional Application No. 60/359,350 which was filed on Feb. 26, 2002 by John Stevens, et al. and assigned to the present assignee, and which are incorporated herein by reference.

### BACKGROUND OF THE INVENTION

1. Field of the Invention

The present invention generally relates to a tote-based warehousing system and method, and more particularly, a tote-based warehousing system and method which may be used in a hybrid retail/warehouse facility.

2. Description of the Related Art

Many inventory-based businesses rely exclusively or heavily on the Internet. However, such businesses (e.g., dotcoms) have often failed, primarily because there are simply too few customers to carry costs. That is, the costs of fulfillment and operating overhead could simply not be covered with the actual customer base. However, the Internet customer base continues to grow by 25% each year, and so the potential for future profits appears evident. For instance, Amazon.com recently had its first profitable quarter ever.

A major barrier to growth for any inventory-based business is managing the physical warehouse, physical inventory, and fulfillment from warehouse to customer. Many companies sell “solutions” that include pick-to-light (PTL) or Dynamic Picking Systems, batch picking with tilt tray sorting, automated crane systems. A major problem with such conventional systems is that volume and throughput commitments must be established before capital and systems commitments are made. If the business plan is wrong and a warehouse faces unexpected expansion, it becomes quite expensive. If the business plan is wrong and the warehouse faces below target throughput, it is a financial disaster. Finally, if throughput is predictable, existing legacy systems are too expensive to change.

Any new initiatives especially retail based ventures must take a long hard look at fundamental economics, value chains and operating costs. For instance, one of the major economic inefficiencies in dotcom businesses is the Internet's dependency upon expensive “old economy” fulfillment channels. In addition, the dotcoms assume that any Internet retail business (i.e., “the e-tailer”) was just like mail order.

After the dotcom collapse none of the fulfillment companies filed for Chapter 11. All claimed 10% to 20% annual growth in new business as a result of the Internet and appear to have had positive Internet cash flows from day one. However the high costs and inefficiencies of these fulfillment channels cause conventional systems to be expensive and inefficient and were directly responsible for the demise of many dotcoms.

More specifically, three basic types of fulfillment systems have been used for retail Internet-based businesses: Central High Volume Automated Warehouse (National Fulfillment Channel), Regional Medium Volume Warehouse (Regional Fulfillment Channel), and Regional Low Volume Store/Warehouse (Regional Fulfillment Channel)

Many examples exist for the first type of system or mail-order model, some successful and some not so successful. The best known success of the second type of conventional system is Corporate Express, with revenues of over $4 billion. In this second type of system, inventive system 100 (e.g., the inventive fulfillment chain) can cut fulfillment costs by as much as 50%.

The third type of system (e.g., Store/Warehouse approach) has worked on a small scale and certainly minimizes capital required to launch any Internet business. However, merely using conventional retail store systems does not have the ability to scale. In other words, merely utilizing a different fulfillment channel without major modifications to the store does not make economic sense for many reasons.

The major advantage of the third type of system (e.g., the retail Store/Warehouse approach) is that the sunk costs associated with inventory and inventory management can be shared by both the Internet and direct in-store retail sales. However, this type of system has two major shortcomings that make it not scalable.

First, the “value chain penalty”. That is the product has come from manufacture to a pallet based central warehouse, broken down into “eaches” (e.g., single items of merchandise), shipped to the store and prepared for shelf-based in-store sales. It has been handled maybe four or five times. The sunk cost for the product on the in-store shelf may be as much as 12% higher than if it were in an optimized “two touch” warehouse environment.

Second, inefficiencies created for the Internet business by an in-store environment where picking eaches and management of inventory is complicated and costly. For instance, many warehouse systems involve placing products on shelves and picking the products based on lights and displays attached to the shelf (e.g., a so-called “Pick and Put to Light” (PTL) system). These systems typically require physical addresses for each item and also require that a “picker” travel to the warehouse shelf to get an item.

Therefore, such conventional systems are inefficient and time consuming. For example, lead to pick rates of 100 or less per hour per employee are not uncommon. Indeed, the inventors believe the warehouse picking penalty for the Internet business might be as much as 4% on sales.

Thus, in the end the products will either cost more for the Internet customer, in addition to the actual fulfillment costs, or the products will cost more for in-store customer.

### SUMMARY OF THE INVENTION

In view of the foregoing and other problems, drawbacks, and disadvantages of the conventional systems and methods, an object of the present invention is to provide a cost and space efficient tote-based warehousing system and method which optimizes each employee's time and leads to highly efficient putting away” (e.g., re-shelving) of products and highly efficient picking of products, and which may be used in a hybrid retail/warehouse facility.

The inventive warehousing system includes a tote (e.g., container) for storing at least one item of merchandise, an electronic (e.g., radio frequency identification (RFID)) module associated with the container, and a controller which wirelessly communicates with the module, for directing a transfer of the item(s) of merchandise to and from the container.

The inventive warehousing system may also include a second container for receiving the item(s) of merchandise from the first container. In this case the controller may also direct a transfer of the item(s) of merchandise from the first container to the second container. In addition, the second container may be associated with a second electronic (e.g., RFID) module which wirelessly communicates with the controller, for facilitating a transfer of the item(s) of merchandise from the first container to the second container.

More specifically, the electronic module may include a light emitting device which is activated to indicate that the item(s) of merchandise should be transferred to and from the first container. The module may also include a display device for indicating a content of the tote (e.g., first container).

In another aspect, the present invention includes a hybrid retail/warehouse system which includes a retail/warehouse facility including a shelving area, and a picking area adjacent to said shelving area, and having a layout so as to minimize a picking area and a walking distance between a picking area and a shelving area. The system also includes a tote (e.g, container) associated with the retail/warehouse facility for storing at least one item of merchandise, an electronic (e.g., RFID) module associated with the container, and a controller which wirelessly communicates with the module, for directing a transfer of the item(s) of merchandise to and from the tote.

Further, the retail/warehouse facility may store merchandise which is personally selected by in-store customers and remotely selected by out-of-store (e.g., Internet) customers.

In another aspect, a warehousing method according to the present invention includes storing at least one item of merchandise in a tote (e.g., container), and remotely directing a transfer of the item(s) of merchandise to and from the tote, using a electronic (e.g., Radio Frequency Identification Device (RFID) module) which is associated with the tote. The inventive method may also include remotely assigning a bag (e.g., second container) to receive the item(s) of merchandise from the tote.

In another aspect, a hybrid retail/warehouse method according to the present invention includes storing at least one item of merchandise in a container which is associated with a retail/warehouse facility, the facility including a shelving area, and a picking area adjacent to said shelving area, and having a layout so as to minimize a picking area and a walking distance between a picking area and a shelving area. The method also includes remotely directing a transfer of the item(s) of merchandise to and from the tote, using an electronic (e.g., RFID) module which is associated with the tote. Further, the merchandise may be personally selected by in-store customers and/or remotely selected by out-of-store customers.

The present invention may also include a signal-bearing media tangibly embodying a program of machine-readable instructions executable by a digital data processor to perform the inventive warehousing method (e.g., hybrid retail/warehousing method).

With its unique and novel features, the present invention optimizes each employee's time and leads to highly efficient put away of products and highly efficient picking of products. The invention, therefore, offers affordable, state-of-the-art technology for managing and improving retail and warehouse operations. The inventive system and method may also be conveniently offered as an independent or integrated solution to supply chain needs.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a schematic drawing illustrating an inventive warehousing system 100;

FIG. 2A-2B illustrate a tote (e.g., container) that may be used in the inventive system 100 according to the present invention;

FIG. 2C-2D illustrate examples of how totes may be arranged on shelves according to the present invention;

FIG. 3A provides a detailed illustration of a tote (container) which may be used in the inventive system 100;

FIG. 3B illustrates an electronic module which may be associated with a tote in the inventive system 100;

FIG. 4A provides a detailed illustration of a smart bag (e.g., container which may be used in the inventive system 100;

FIG. 4B illustrates an electronic module which may be associated with a smart bag in the inventive system 100;

FIG. 5A-5B are schematic drawings illustrating a layout of an inventive warehousing system 100 according to the present invention;

FIG. 6 illustrates an inventive hybrid retail/warehouse system 100 according to the present invention;

FIG. 7A illustrates a conventional warehouse system, and FIG. 7B illustrates a comparably-sized warehouse utilizing the inventive hybrid retail/warehouse system 600;

FIG. 7C illustrates a conventional warehouse system, and FIG. 7D illustrates a comparably-sized warehouse utilizing the inventive hybrid retail/warehouse system 600;

FIG. 8 is a flow chart illustrating an inventive warehousing method 800 according to the present invention.

FIG. 9 illustrates an inventive hybrid retail/warehouse method 900 according to the present invention;

FIG. 10 illustrates a typical hardware configuration which may be used for implementing the system and method according to the present invention; and

FIG. 11 illustrates an example of a signal-bearing media which may be used to implement the system and method according to the present invention.

### DETAILED DESCRIPTION OF PREFERRED EMBODIMENTS OF THE INVENTION

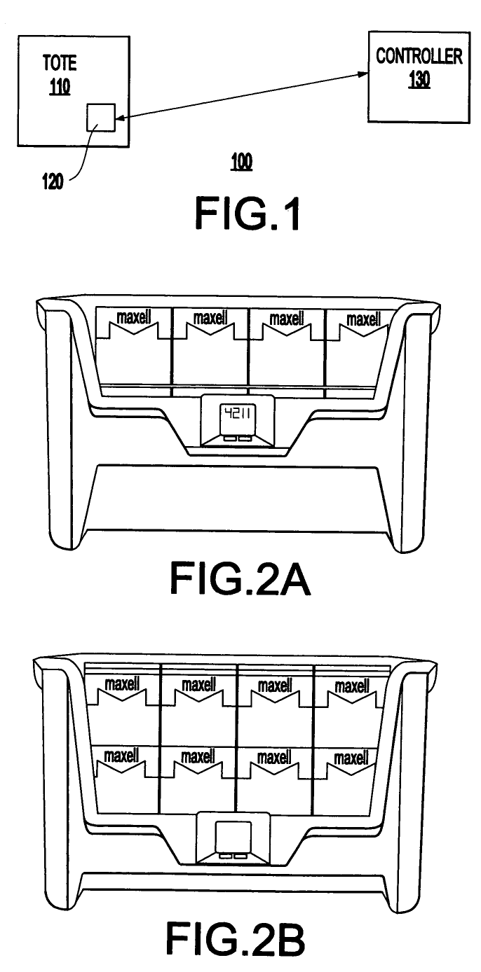

Referring now to the drawings, and more particularly to FIGS. 1-11, there are shown preferred embodiments of the system and method according to the present invention.

As shown in FIG. 1, an inventive tote-based warehousing system 100 includes a tote 110 (e.g., container) for storing at least one item of merchandise, an electronic (e.g., first radio frequency identification (RFID)) module 120 which is associated with the first container, and a controller 130 which wirelessly communicates with the module, for directing a transfer of the item(s) of merchandise to and from the first container.

As described below, the inventive system 100 optimizes each employee's time and leads to highly efficient “put away” (e.g., shelving) of merchandise and highly efficient “picking” of merchandise. The inventive system 100 is based in part on a wireless tote system that may use display modules and short range low frequency RF transmitted through loop antennas similar to those used for grocery store pricing modules.

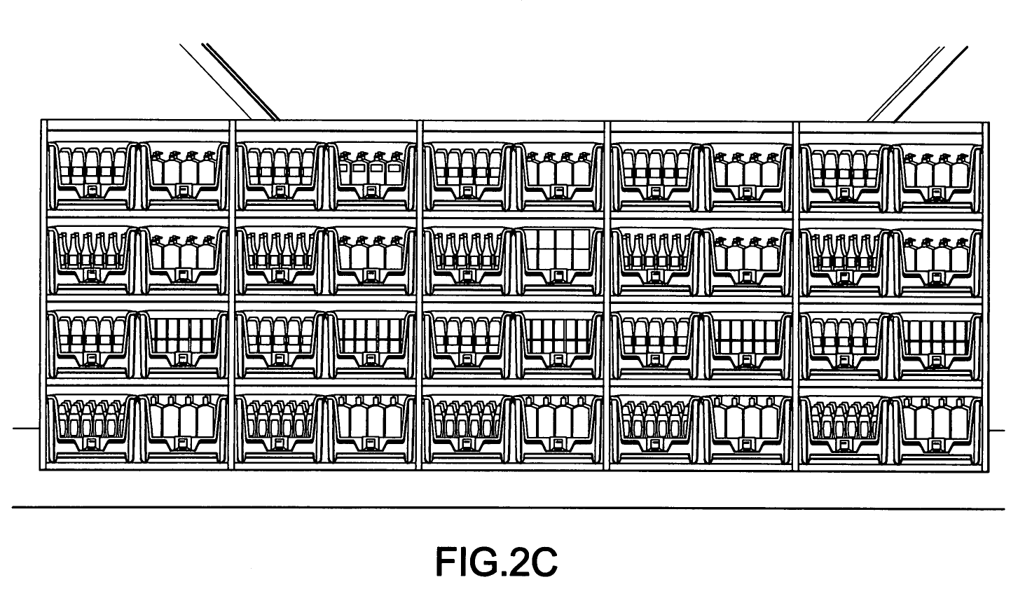

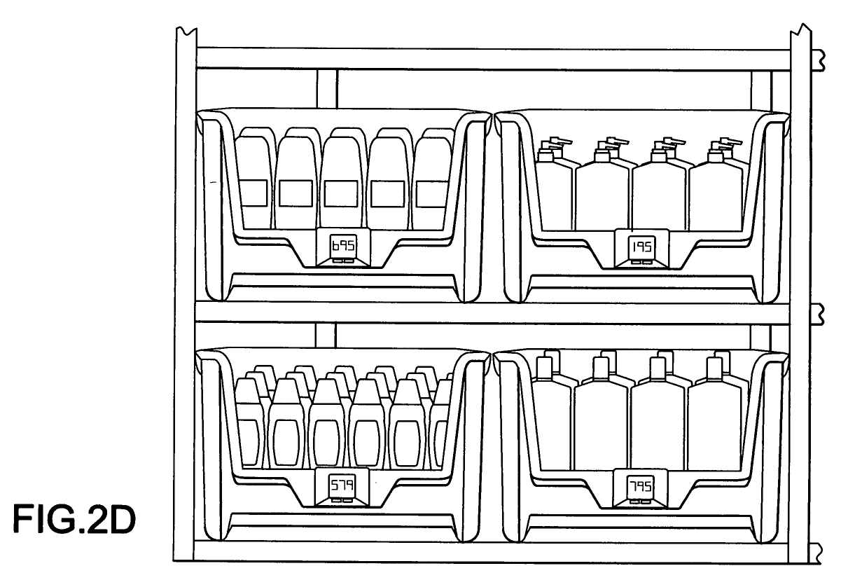

In addition, as shown in FIGS. 2A-2B, the tote 110 used in the inventive system 100 may be formed of varying dimensions and may be used to store several items of merchandise. For example, the tote 110 may be small enough to hold bolts and spices, or large enough to hold 50 Lb bags of dog food. In fact, for very large items the tote 110 may resemble a pallet in a pallet based system.

For instance, the tote 110 may have suitable dimensions (e.g., approximately 18″×18″ by 24″ in an exemplary non-limiting embodiment) and may be made from conventional materials (e.g., plastic). The tote 110 may be smaller or larger, and a warehouse may use a plurality of totes 110 having a variety of sizes. In addition, as shown in FIGS. 2C-2D, the tote 110 may be easily stored on store shelves to provide for a very neat and organized presentation of the merchandise.

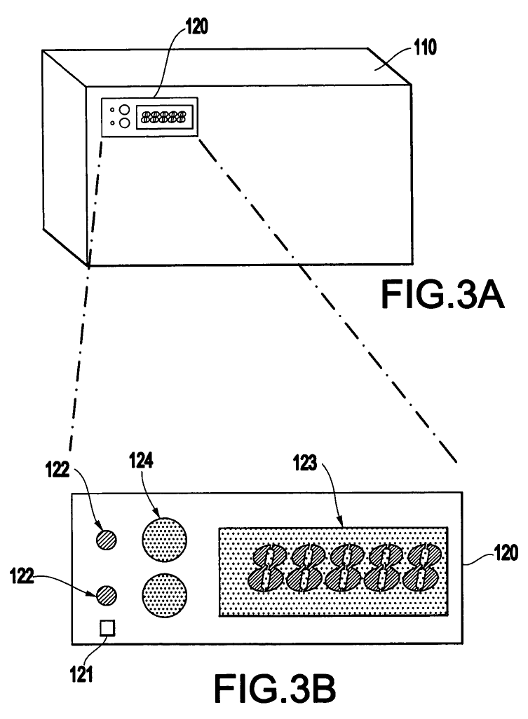

In addition, as shown in FIG. 3A, associated with each tote is an electronic module 120 (e.g., radio frequency identification module (RFID)). For example, the electronic module 120 may be affixed (e.g., attached) to the tote 110. More specifically, the module 120 may be a wireless battery operated module capable of two-way communication.

As shown in FIG. 3B, each module 120 may include a memory device 121 (e.g., semiconductor memory; random access memory (RAM) for storing a unique identification (ID) number, two light emitting devices 122 (e.g., light emitting diodes (LEDs)) which may have different colors (e.g., red and green), a display device 123 (e.g., liquid crystal display (LCD)) which may include a five-digit display, and at least one device 124 (e.g., button) for activating/deactivating a feature of the module 110 (e.g., the LED, display device, etc.).

Of course, many variations of the module 120 configuration are possible. The module 120 may use a low power complementary metal oxide semiconductor (CMOS) circuitry and, with a standard lithium battery, will operate for a period of many years. The memory device 121 may also store button pushes or other parameters associated with the status of the tote (e.g., weight, temperature, etc.). The memory device 121 may also store identification numbers (e.g., UPC) corresponding to items of merchandise which are contained in the tote 110 or which are to be transferred to or from the tote 110.

The inventive warehousing system 100 also includes a controller 130 which wirelessly communicates with the module 120. The controller 130 directs a transfer of the item(s) of merchandise to and from the tote 110.

For example, the controller 130 may include a processor (e.g., microprocessor), memory device and two way radio device (e.g., transmitter/receiver). For instance, the controller 130 may include a computer system which is capable of directing a radio transmitting/receiving function. For instance, the controller 130 may wirelessly communicate with the module 120 using low frequency (e.g., 300 Ghz) two-way radio frequencies.

The inventive warehousing system 100 may also include an antenna (e.g., antennas) (not shown) to facilitate communication between the controller 130 and the module 120. The antenna may include one or more antenna loops (e.g., wire loops) and communication may be limited to the area within a loop. These antenna loops can be placed in the floor, behind a shelf or in the ceiling.

Thus, when a given loop is activated, it can poll for a specific module 120 and if the module 120 is present, it can be made to respond to the poll. In other words the controller 110 (e.g., a software system operated by the controller 130) can direct a search of the entire warehouse, loop by loop polling for a specific module 110, and locate the presence or absence of a module 120. When the software system establishes communication, the inventive warehousing system 100 can cause the module's display device 123 to display a particular number, read whether a particular button 124 has been pushed or not, turn an LED 122 (e.g., red, green, etc.) on or off, read back the identification number of the module 120, read the contents of the memory device 121, etc.

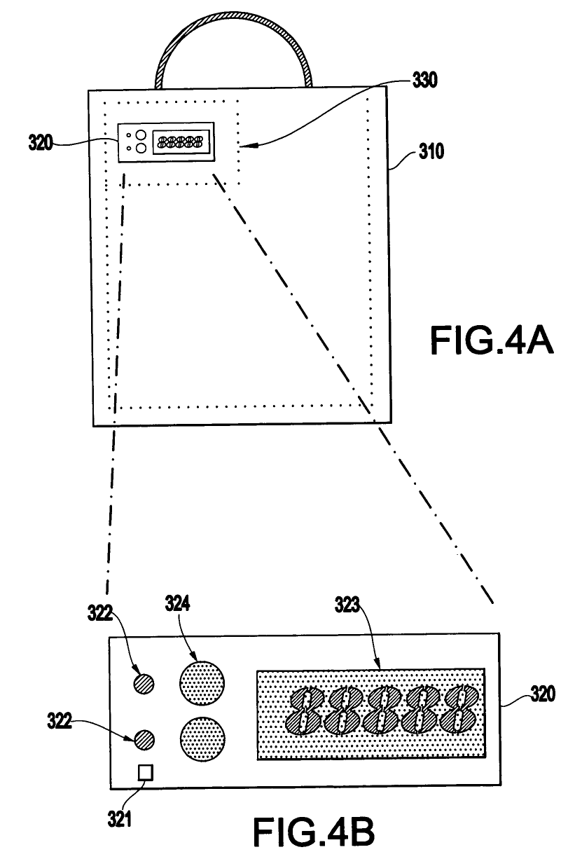

As shown in FIG. 4A, the inventive warehousing system 100 may also include a smart bag 310 for receiving items of merchandise from the tote 110. Generally, the features described above for the tote 110 can also be provided by the smart bag 310. For example, the smart bag 310 may be made of conventional materials, such as plastic or canvas.

Further, as shown in FIG. 4B, the smart bag 310 may also be associated with an electronic module 320 similar to the module 110 discussed above. For instance, the module 320 may include a memory device 321 (e.g., semiconductor memory; random access memory (RAM) for storing a unique identification (ID) number, two light emitting devices 322 (e.g., light emitting diodes (LEDs)) which may have different colors (e.g., red and green), a display device 323 (e.g., liquid crystal display (LCD)) which may include a five-digit display, and at least one device 324 (e.g., button) for activating/deactivating a feature of the module 320 (e.g., the LED, display device, etc.).

Further, the module 320 may be affixed to the smart bag 310. For instance, the smart bag 300 may include a pocket 330 on the front of the bag 310 for containing the module 320. Further, the smart bag 310 may also contain an optional second bag (not shown) that can be used to hold products for delivery.

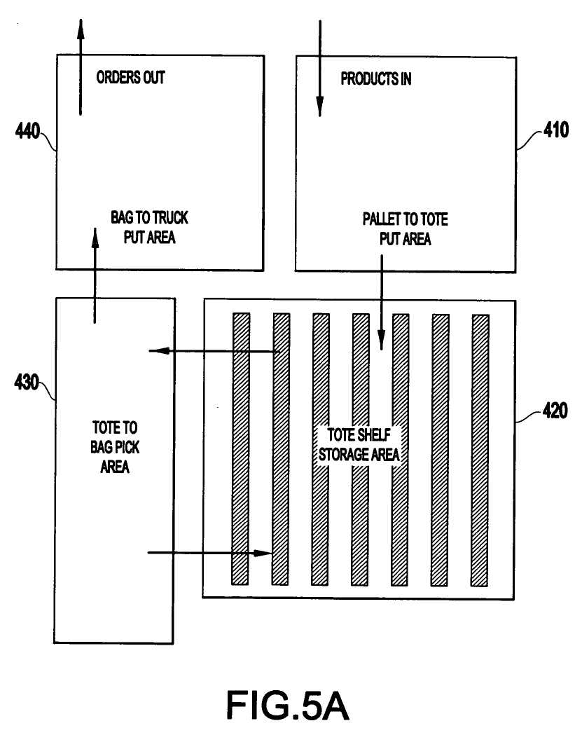

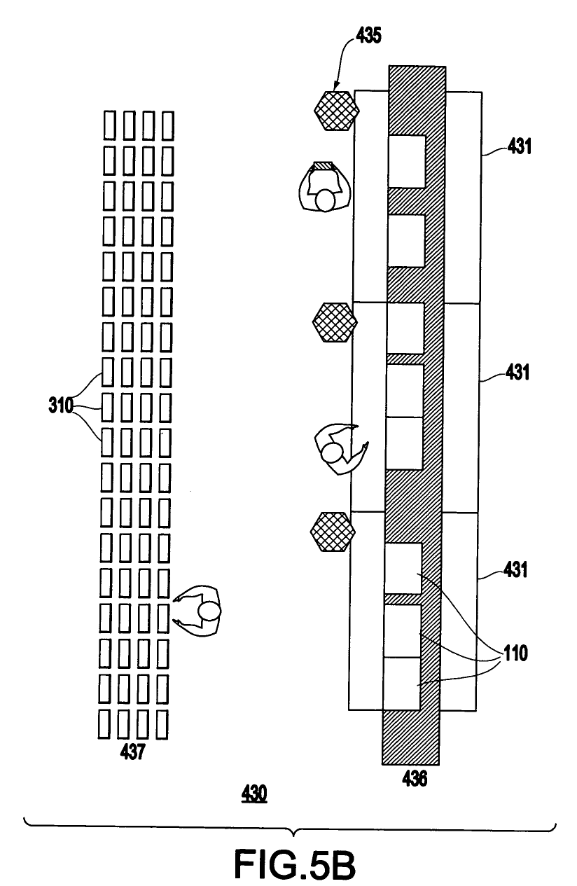

The inventive tote-based warehousing system 100 provides a fast and efficient tool for picking and putting away merchandise and may be used in virtually any setting (e.g., retail, warehouse, hybrid retail/warehouse, etc.). For instance, FIGS. 5A and 5B illustrate examples of how the inventive warehousing system 100 may be implemented according to the present invention.

As shown in FIG. 5A, items of merchandise may arrive at the facility (e.g., a warehouse) on pallets. As soon as the merchandise is identified (from bar codes or the invoice), it may be moved to a “pallet to tote put area” 410 (e.g., staging area). The number of totes 110 required to hold all of the product from the pallet may be calculated by the controller 130 (e.g., the system software), and the required number of totes 110 may be transferred into the put area 410 automatically.

A database (e.g., controller database) links the unique identification number of each tote 110 with the item of merchandise and the number of items of merchandise that should be placed in the tote 110. The pallet may be manually unpacked item by item and placed in the totes 110. Each tote 110 may be weighed as a cross-check that the number of items are correctly packed into the tote 110.

Referring again to FIG. 5A, the packed totes 100 may be moved into the shelf storage area 420 using, for example, a conveyor or truck. Each tote 110 may be placed on the shelf in whatever order and in any available place the worker might find empty. For example, the totes 100 may be placed randomly on shelves. Further, the shelves may contain many thousands of totes 100 on shelves.

The controller 130 may communicate with a module 120 on a particular tote 110 to indicate that an item of merchandise contained in that particular tote 110 is to be transferred. For instance, the controller 130 may cause the module 120 to activate an LED 122 which can be seen by operator to indicate that an item is to be transferred from that particular tote 110. (It should be noted that the module 120 may include an audible signal (e.g., bell) instead of the LED 122 as an indicating device).

The tote 110 indicated by the controller 130 may be transferred (e.g., by an operator or automatically) from the shelf storage area 420 to a tote to bag pick area 430. Here, the item of merchandise may be transferred from the tote 110, for example, for delivery to a purchaser. For example, the item of merchandise may be transferred from the tote 110 to a smart bag 310. The smart bag 310 containing the item of merchandise may be transferred from the tote to bag pick area 430 to a bag to truck put area 440 to await transfer out of the facility.

Specifically, FIG. 5B provides a detailed illustration of a tote to bag pick area 430. As shown in FIG. 4B, the picking area 430 may include a conveyor lane 436 and a picking lane 437.

When an operator (e.g., a “shelf picker”) sees a light flashing on a tote 110 in the shelf storage area 420, he may remove the tote 110 from the shelf and place it in a conveyor lane 436 (e.g., conveyor belt) that takes it to a picking area 430. As the tote 110 moves to the picking area 430, the red LED is turned off. The tote 110 arrives at the picking area 430 and goes past several picking regions 431 until it comes to the region that has a bag 310 assigned to the order.

When that particular tote 110 reaches that region 431, the controller 130 (e.g., software) causes the red light on the module 120 on that particular tote 110 to activate again. The “packing picker” sees the light flashing an removes the item from the tote 110.

The operator may scan the item removed from the tote 110 using a scanner 435 provided in the picking area 430. The controller 130 (e.g., software system) detects that the correct item has been scanned and turns off the tote's LED.

The operator may transfer the item of merchandise to the picking lane 437 where smart bags 310 may be assembled. The controller 130 may (e.g., simultaneously with deactivating the tote LED) activate an LED on a smart bag 310 in the picking lane 437 that is supposed to receive the item of merchandise. The packing picker may place the item in the bag 310 that is flashing.

The picking area 430 may also contain a weight detection device (not shown) which allows the smart bag 310 to be weighed so as to detect a change in the weight of the smart bag 310 when an item is placed in the smart bag 310. For instance, when a predetermined weight change is detected, the LED on that particular smart bag 310 may be deactivated (e.g., by the weighing device or by the controller 130 which communicates with the weighing device).

After the item has been removed from the tote 110, the tote 110 may continue on the conveyor belt and eventually return to the shelf storage area 420. As the tote 110 moves towards the shelf storage area 420 the controller 130 may activate an LED on the tote module 120 (e.g., the green LED) to indicate that the tote 110 should be placed back on the shelf. When the shelf picker may see the green flashing light on the tote 110 and remove the tote 110 from the conveyor and place it back on the shelf (e.g., in a random order).

Thus, for example, the shelf picker may simply pick red light totes and place them on the conveyor towards the picking area, and green flashing totes and put them back on the shelves. Therefore, the packing pickers may, for example, work within their region in the packing area 430 and simply take items from a red flashing tote in the conveyor lane 436, scan it and place it in the bag 310 that has a flashing light in the picking lane 437. A tote 110, the items in which have not been picked, may simply stay on the conveyor belt to return to the picking regions 431. It may also be possible to keep high volume items of merchandise (e.g., items that are frequently picked) on a special conveyor behind the pick lane 437 so that they may be easily moved to the pick lane.

Hybrid Retail/Warehouse Facility

The inventive tote-based warehousing system and method may be efficiently and effectively incorporated, for example, in a hybrid retail/warehouse system.

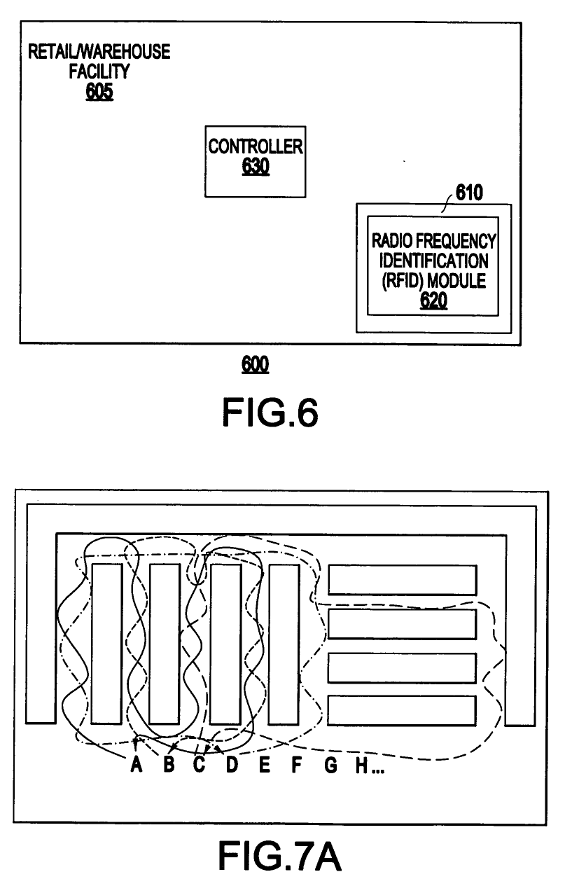

As shown in FIG. 6, an inventive hybrid retail/warehouse system 600 includes a retail/warehouse facility 605 for storing merchandise. The retail/warehouse facility 605 may store merchandise which may be either personally selected by in-store customers and/or remotely selected by out-of-store customers. For example, the retail/warehouse facility 605 may be designed to handle both retail customers who are shopping in person and personally taking items of merchandise from the shelves for purchasing. However, the facility 605 may also be designed to handle customers that are remotely purchasing items such as over the Internet (e.g., the World Wide Web). Thus, the facility 605 may be equipped to conveniently take orders over the Internet.

The inventive hybrid retail/warehouse system 600 also includes a tote 610 (e.g., container) associated with the retail/warehouse facility 605 for storing at least one item of merchandise, an electronic module 620 (e.g., a radio frequency identification (RFID) module) associated with the tote 610, and a controller 630 which wirelessly communicates with the module 620, for directing a transfer an item of merchandise to and from the tote 610.

Specifically, the tote 610, electronic module 620 and controller 630 may have features comparable to those discussed above with respect to the tote 110, electronic module 120 and controller 130 in the warehousing system 100 above. In addition, the operation of the inventive hybrid retail/warehouse system 600 is comparable to the operation of the warehousing system 100 explained above with respect to FIGS. 5A-5B.

In short, the inventive system 600 provides a highly efficient, low capital cost solution that also can be easily scaled with throughput growth at low costs. The cost-effective scalability feature makes the inventive system 600 an attractive component in the Corporate Network product. Further, the inventive system 600 is ideally suited to serve uncertain inventory requirements. The system 600 can serve the full range and be quickly retrofitted at a low cost to increase productivity or be used as a simple pick-to-light in aisle system.

In other words, the inventive system 600 provides an inventive “new economy” fulfillment channel, that can save as much as 50% in regional fulfillment costs. The inventive channel may be based, for example, on optimized un-attended night-time delivery to a network of proprietary, secure drop box's.

The inventive system 600 may be used, for example, for business-to-business (B2B) corporate fulfillment (e.g., critical parts, industry specific networks, wholesale fulfillment, and private corporate networks). However, the inventors believe retail fulfillment also offers a significant opportunity and can also benefit from the inventive system 600 and its related technology.

Unlike conventional systems, the inventive hybrid retail/warehouse system 600 provides optimized high throughput for each picking. The inventive system 600 relies in part on the electronic module 620 associated with the tote 610. However, unlike many radio frequency (RF) tag devices in conventional systems (and comparable to the features discussed above with respect to module 120) the module 620 may include: two LED's, an 8 Digit LCD, three operating switches (e.g., activating/deactivating buttons), a two way 300 Khz 1200 baud RF link, programmable functionality, and a preprogrammed unique identification (e.g., ID number). Further, each module 620 may be used to display retail price and unit price, in addition to displaying all other warehouse functions on demand for in-store pickers, including pick-to-light LEDs.

Referring again to FIG. 6, the controller 630 wirelessly communicates with the RFID module 620, in order to identify and locate items of merchandise. It should be noted that FIG. 6 is merely illustrative and that the controller 630 may be located within or outside the facility 605. Likewise, the RFID module may be located either inside or outside the facility 605 and still be controlled by the controller 630.

The inventive system 600 provides a low-cost, small-footprint pick-to-light fulfillment system that can use the controller 630 to “find” an item of merchandise in a warehouse (e.g., a hybrid retail/warehouse facility 605). Using a unique Radio Frequency Identification (RFID) module, the controller 630 allows random, dynamic placement of inventory for either pick or put-away. The controller 630 can “find” and recognize the location of any randomly placed inventory with periodic scans of the warehouse.

In addition, inventive system 600 is very flexible. Its installation can be configured to as low as 2,000 totes or modules, yet there is no practical limit on the size of facility or number of SKUs.

The inventive system 600 further provides a wireless, real-time fulfillment system using pick-to-light (PTL) and RFID technology which may be coupled with a proprietary inventory location and positioning software which may be executed, for example, by the controller 630. The controller 630 allows for the identification and placement of inventory anywhere in the warehouse without the rigid structures of predetermined inventory locations or addresses.

Further, the proprietary wireless display module 620 is designed so as to allow the central controller 630 to selectively “talk” to the module 620 when it is located anywhere in or around the warehouse facility 605. In addition, the modules 620 can be attached to any inventory unit (e.g., each/tote/pallet, etc.). Once an SKU is identified to the module 620, an item of merchandise may be placed anywhere in or around the facility 605 and the controller 630 will “locate” it.

Further, the inventive system 600 is configurable to any warehouse operation. Its basic functionality may include, for example, receiving, dynamic or traditional addressed put-away, dynamic picking, packing, shipping, cross docking, productivity measurement, labor management, dynamic slotting, re-warehousing (storage consolidation), RF communications for all functions, automatic replenishment, expiration dating, batch/lot control, report generation, order management, wave management, weight check, cycle counting

### COMPARATIVE EXAMPLES

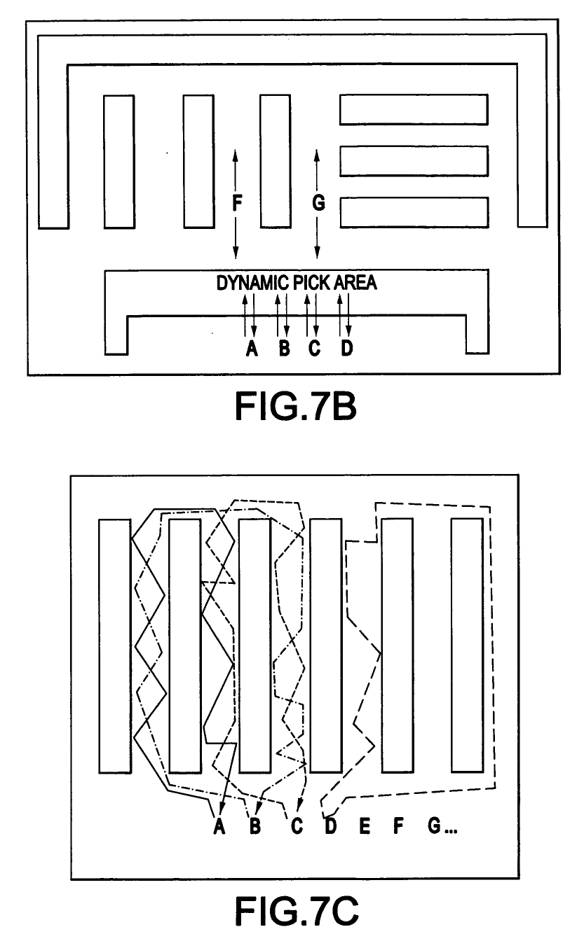

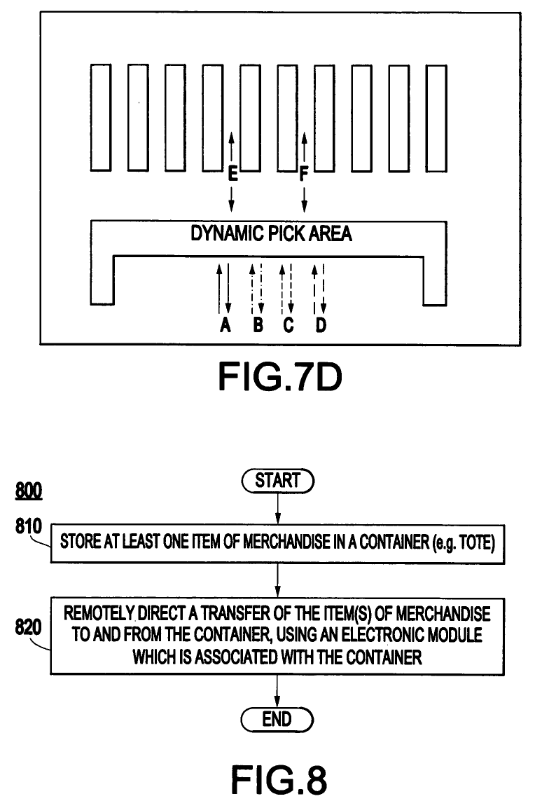

FIG. 7A illustrates a conventional warehouse system, and FIG. 7B illustrates a comparably-sized warehouse utilizing the inventive hybrid retail/warehouse system 600.

Specifically, FIG. 7A illustrates a conventional warehouse which may include, for example, a typical 250,000 sq.ft. distribution center (500′×500′) in which all SKUs have location addresses assigned to them, either random or fixed. All locations within the facility are active, picking can occur throughout the facility. It is assumed that 20 pickers are required to pick 200 orders for this hypothetical operation.

Traditional pick-paths can span the entire warehouse to find the “B” and “C” items in a pick list.

It may be assumed, for example, that within such a conventional distribution operation, 75% of a picker's time will be spent traveling, and an average multi-pick order will require the picker to travel 60% of the total aisle distance within the picking area. In this case there are 7 aisles, 300 feet each; at 60% average order batch travel will be 1,260 feet and 200 batches will require travel of 252,000 feet per day (7 aisles×300 feet×60%×200 order batches). Assuming 20 pickers are required to fulfill, the average picker travel will be 12,600 feet per day. Therefore the standard output per picker is 12,600 feet per day.

FIG. 7B, on the other hand, illustrates a warehouse utilizing the inventive system 600 and which includes a Dynamic Pick Area A B C D F G. The inventive system 600 allows a much smaller pick area. In addition, a limited number of people locate the “B” and “C” totes and position them within the picking area.

Specifically, FIG. 7B illustrates a distribution center with 25,000 sq.ft. picking area, with 825 feet of aisles (11 aisles×75 feet) and 225,000 sq.ft. for back stock. This methodology may require two (2) full-time replenishers. However, since the picking area is geographically smaller and travel distances are shorter, there will be fewer pickers required. Using the math from the first illustration: 200 order batches×(825×60%)/12,600 feet/day/picker (performance standard)=8 pickers required. 8 pickers+2 replenishers=10 total headcount for a 10 headcount reduction. Paybacks of less than one year can be attained using the presently disclosed inventive system 600.

Referring again to the drawings, FIG. 7C illustrates a conventional warehouse system, and FIG. 7D illustrates a comparably-sized warehouse utilizing the inventive hybrid retail/warehouse system 600.

FIG. 7C illustrates second example of a conventional warehouse system A B C D E F G . . . As shown here, conventional pick-paths can span the entire warehouse to find the “B” and “C” items in a pick list.

Specifically, FIG. 7C illustrates a typical 250,000 sq.ft. distribution center (500′×5800′) in which all SKUs have location addresses assigned to them, either random or fixed. All locations within the facility are active, picking can occur throughout the facility.

It may be assumed, for example, that 20 pickers are required to pick 200 orders for this hypothetical operation. It may also be assumed that, within distribution operations, 75% of a picker's time will be spent traveling, and an average multi-pick order will require the picker to travel 60% of the total aisle distance within the picking area.

In this case there are 7 aisles, 300 feet each; at 60% average order batch travel will be 1,260 feet and 200 batches will require travel of 252,000 feet per day (7 aisles×300 feet×60%×200 order batches). Assuming 20 pickers are required to fulfill, the average picker travel will be 12,600 feet per day. Therefore the standard output per picker is 12,600 feet per day.

FIG. 7D, on the other hand, illustrates a facility using the inventive system 100 as applied to a picking operation. As shown in FIG. 7D, the inventive system 600 allows a much smaller pick area. A limited number of people locate the “B” and “C” totes and position them within the picking area (e.g., dynamic pick area A B C D E F.

Specifically, FIG. 7D illustrates the a distribution center with 25,000 sq.ft. picking area, with 825 feet of aisles (11 aisles×75 feet) and 225,000 sq.ft. for back stock. This methodology will require two (2) full-time replenishers, however since the picking area is geographically smaller and travel distances are shorter, there will be fewer pickers required. Using the math from the first illustration: 200 order batches×(825×60%)/12,600 feet/day/picker (performance standard)=8 pickers required. 8 pickers+2 replenishers=10 total headcount for a 10 headcount reduction. Paybacks of less than one year can be attained using the inventive system 600.

This example, assumes, for instance, that each headcount=$15.00 US/hr including fringes, and that each headcount=2080 hours/year (no overtime). It also assumes a 250,000 sq.ft. warehouse cost at $4.00 US per sq.ft. $1,000,000 US inventory.

Therefore, the cost of the inventive system 600 may include installation w/20,000 totes $250,000, employee retraining 8 hrs×20 HC 2,400, maintenance agreement (15%) 37,500, and contingency (10%) 25,000. Thus, the total cost is about $314,900.

In other words, the inventive system 600 results in savings over the convention al system. For instance, assuming a 10 headcount reduction (10×$15×2080) $312,000, space utilization improvement 15% 50,000, and inventory utilization improvement 5% 50,000, the total savings is about $362,000.

Other Features

An important feature of the inventive system 600 is that location of merchandise does not need to be assigned. All movement—whether put-away, re-stocking, receiving or shipping—can be random and dynamic. The controller 630 will locate the SKU, tote, or pallet and update the system 600. All merchandise within or around the facility 605 may be identified with modules 620 which are continuously interrogated by the controller 630 for quantity and physical location of the merchandise.

This unique attribute is invaluable in fast paced, dynamic warehouse environments such as fashion, seasonal businesses, and service parts. The ability to dynamically slot picking areas allows the warehouse to keep a small picking footprint. The ability to dynamically consolidate put-away areas keeps those storage areas densified and opens empty slots for inbounds.

There are other important features of the inventive system 600 which make it more efficient than conventional systems. For example, the receipt process ties a single unit of product (each, tote, pallet, etc) to a single module 620 which may be automatically tracked by the controller 630. Further, Received product is simply put into the next available picking or storage slot anywhere in the warehouse (e.g., dynamic put-away). The controller 630 takes care of the tracking. This user-friendly approach allows operators more freedom to manage the flow of inbound inventory.

In addition, the system 600 provides for dynamic picking. For instance, occasionally, a “B” item becomes an “A for a day” and these items can be moved forward in real-time by the pickers, while slower moving items “B for a day” can be moved back using the same methodology. The system 600 also provides for cross-docking. For instance, during the receiving process, the controller 630 will automatically identify product to be cross docked and will notify receiving personnel through the display on the module 620. The product is then directed to the appropriate packing or shipping area. The system 600 also helps to facilitate productivity measurement. That is, the controller 630 may contain productivity reporting capabilities and interface with all conventional warehouse productivity software.

The system 600 also provides for dynamic slotting. For example, as the velocity of products change, the controller 630 may direct the movement of product to specific aisles or slots. Replenishers may be directed to move fast movers to the front of the picking area, slower movers back, and “C” items will be removed to storage if there is no future picking requirement. It should be noted that there is no requirement to return the “C” item to a fixed address, because it can be replaced anywhere in storage and the controller 630 will find it. The controller 630 updates the new location of the product automatically, and directs pickers or replenishers to the “new” location.

Further, the system 600 provides for pick path optimization. Specifically, pickers and replenishers may be directed through the most efficient pick paths to optimize productivity (e.g., a picking area may be minimized and a walking distance between a shelving (e.g., storage) area and a picking area may be minimized).

The system 600 also facilitates re-warehousing (storage consolidation). In other words, partially depleted totes may be moved to half-tote locations to densify the storage area. Again the controller 630 may automatically update the new location of the product.

Further, wireless (e.g., radio frequency) communications may be used for all functions, thereby providing for automatic replenishment. In other words, since the controller dynamically tracks the location and quantity of all products in the warehouse, replenishment signals may be triggered to keep the right product in the pick area, just in time.

The system 600 can be incorporated at receipt to so as to facilitate expiry dating. In other words, the controller 630 can be configured to “find” the oldest product to reduce expiry dating write-downs. The system 600 may also aide in batch/lot control. The system 600 is completely variable and operator controllable to assure that the right mix or match of products is sent to the right customer. Last in first out (LIFO), first in first out (FIFO), least costly first, most costly first, expired product flash, and more are available in the controller 630.

The system 600 also facilitates cycle counting. In other words, the system 600 is configurable to meet the audit requirements of any company. Pickers may transmit (e.g., directly transmit) inventory discrepancies or replenishers to the controller 630 to trigger full scale cycle counts by SKU, tote, expiration date, batch, etc.

In addition, the inventive system 600 is consistent and compatible with many current warehouse operations and systems. This is a significant benefit to organizations that have invested heavily in a traditional warehouse management system (WMS) and desire to add the module 620 and controller 630 functionality to their existing systems.

Economic Analysis

The inventors carried out preliminary economic analysis and marketing interviews and concluded that a retail store which utilizes the inventive hybrid retail/warehouse system 600 will overcome the major disadvantages of value chain issues and in-store picking of merchandise. The store would effectively be able to sell “two touch” merchandise at a retail level.

Additionally, such retail stores with the inventive system 600 will have low costs associated with merchandise shelf maintenance, and provide the consumer with a neat orderly appearance. Such stores would also have very low planogram requirements, product maintenance inventory management costs, and the ability to modify and re-set store layout in a matter of only a few hours. Such a store would also have many inventory maintenance advantages, and the ability to optimize pricing to consumers.

In addition, such stores using the inventive system 600 may overcome one of the major consumer objections to bulk discount stores, namely “that it costs too much to shop because your forced to buy in large quantities”. In other words, a store using the inventive system 600 will permit the store to sell individual items of merchandise at discount bulk prices, for both in-store and out-of-store (e.g., internet/catalog) sales.

Advantages

The advantages of the inventive system 600 over a conventional shelf-based system with a traditional warehouse management system (WMS) are numerous. For example, the system 600 provides for captive customers, and strong customer conversion. Most in-store customers would make use of Internet and visa-versa. The system 600 also makes it possible to sell individual items in-store at prices competitive to discount bulk in competition. This is considered a consumer barrier to current bulk stores. In addition, the system 600 provides strong economic and value chain justification.

Further, the totes provide enormous savings in software and systems complexity, and product handling and space management efficiencies. Totes have a long history of success in Europe, where many manufactures are required to deliver all back-door products packed in totes. The totes can also provide a neat orderly looking store.

In addition, the system 600 provides electronic pricing and price optimization which is essentially free, and has stand-alone economic advantages. Further, the electronic management of merchandise location or planogram has a low cost and is easy to implement. Moreover, store re-set can be carried out at much lower cost. In addition, the software systems and product inventory management software in the system 600 are not complex compared to conventional in-store systems.

In addition, the modules 620 are relatively inexpensive (e.g., less than $5.00 per module). Further, the software used to manage merchandise picks and inventory that replaces current warehouse management system (WMS) software is simple. This is at least in part because the system 600 may be based on totes not SKUs. Moreover, physical location of the merchandise can be managed and detected by the software in the warehouse, and merchandise can be re-set based on whatever optimization might be required.

By flashing light-emitting devices (e.g., light-emitting diodes (LEDs)) on items of merchandise to be picked, the pick rates may be doubled, put costs reduced, inventory management simplified, particularly with same SKU's that have different cost basis or expiration dates. Furthermore, physical inventory is simple, warehouse re-sets can be carried in matter of only few hours, and merchandise location in warehouse can be optimized on almost a daily basis.

Conventional paper based operations can retain their existing warehouse storage philosophy and simply implement the inventive system 600 in a picking area. This is an excellent use of capital and the inventive system's capabilities. Improving picking productivity by 20-40% will justify the capital expenditure for the system 600, due to the system's low investment. For instance, if a company employs 20 or more warehouse personnel, an improvement in performance of only 4-6 headcount will justify the cost of the system 600. In addition, the system 600 is expandable and scalable, allowing warehouse operations to grow with their expanding businesses and markets.

Further, documentation and support of the controller 630 may include operations manuals, training documentation and support, installation manual, installation technical support, technical help desk, and full release and documentation of the controller 630 source code. Maintenance agreements in one (1) to five (5) year increments may also be available at 15% of installation annually, which will include all upgrades and modifications.

In short, the inventive system 600 provides fast paced quickly changing distribution operations the accuracy and efficiency of a conventional pick-to-light system without the high cost and static positions of hard-wired displays.

Further, the open code structure allows the inventive system 600 to easily interface with existing legacy business systems, enterprise resource planning systems (ERP) or existing inventory/warehouse management systems.

Specifically, the modules 620 may include a proprietary design. Briefly, though, each module 120 may contain a custom communication chip. A typical warehouse utilizing the inventive system 600 may include, for example, approximately ten (10) base stations for communication, a central controller, and approximately 20,000 totes for a total cost of under $250,000 installed. This is relatively inexpensive, compared to conventional WMS and PTL which cost approximately $100 to $250US per location.

Other benefits of the inventive system 600 may include: installation costs 50-75% below traditional WMS-based PTL systems, improved picker accuracy to 99%+, improved picker productivity of 20-40% compared to non PTL installations, Space reductions up to 25% due to more effective space utilization, dynamic ABC, dynamic storage consolidations, Inventory reductions due to improved accuracy, consolidation, real-time, and cross-dock capabilities, Operator accountability, Real-time transaction capture, Paperless warehouse environment, 24×7 customer service/help desk, and Installation support.

Referring to FIG. 8, another aspect of the present invention includes an inventive warehousing method 800. As shown in FIG. 8, the inventive method includes storing (810) at least one item of merchandise in a first container, and remotely directing (820) a transfer of the item(s) of merchandise to and from the first container, using a Radio Frequency Identification Device which is associated with the first container.

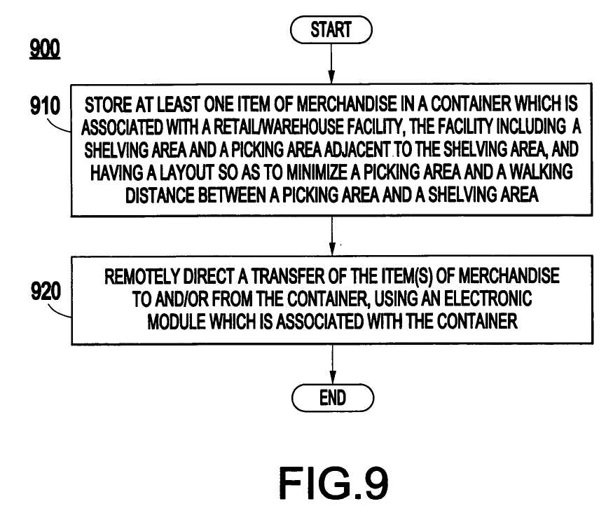

In addition, FIG. 9 is a flowchart an inventive hybrid retail/warehouse method 900. As shown in FIG. 9, the inventive method 900 includes storing (910) at least one item of merchandise in a first container which is associated with a retail/warehouse facility, and remotely directing (920) a transfer of the item(s) of merchandise to and from the first container, using a Radio Frequency Identification Device which is associated with the first container.

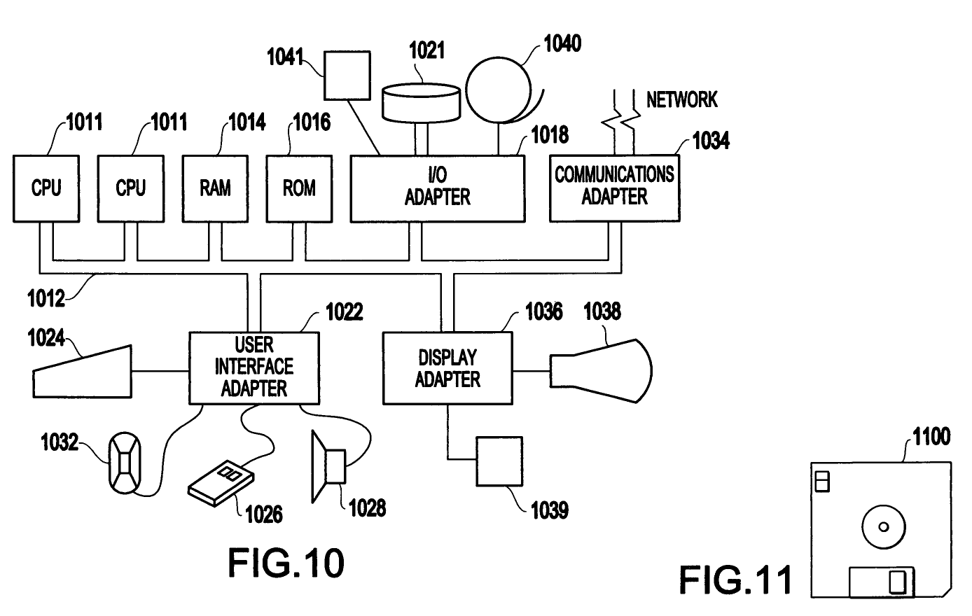

Referring again to the drawings, FIG. 10, illustrates a typical hardware configuration which may be used for implementing the inventive system 100, 600 and method 800, 900. The configuration has preferably at least one processor or central processing unit (CPU) 1011. The CPUs 1011 are interconnected via a system bus 1012 to a random access memory (RAM) 1014, read-only memory (ROM) 1016, input/output (I/O) adapter 1018 (for connecting peripheral devices such as disk units 1021 and tape drives 1040 to the bus 1012), user interface adapter 1022 (for connecting a keyboard 1024, mouse 1026, speaker 1028, microphone 1032, and/or other user interface device to the bus 1012), a communication adapter 1034 for connecting an information handling system to a data processing network, the Internet, and Intranet, a personal area network (PAN), etc., and a display adapter 1036 for connecting the bus 1012 to a display device 1038 and/or printer 1039. Further, an automated reader/scanner 1041 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 1011 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 1011 and hardware above, to perform the method of the invention.

This signal-bearing media may include, for example, a RAM contained within the CPU 1011, as represented by the fast-access storage for example. Alternatively, the instructions may be contained in another signal-bearing media, such as a magnetic data storage diskette 1100 (FIG. 11), directly or indirectly accessible by the CPU 1011.

Whether contained in the computer server/CPU 1011, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

With its unique and novel features, the present invention optimizes each employee's time and leads to highly efficient put away of products and highly efficient picking of products. The invention, therefore, offers affordable, state-of-the-art technology for managing and improving retail and warehouse operations. The inventive system and method may also be conveniently offered as an independent or integrated solution to supply chain needs.

While the invention has been described in terms of several preferred embodiments, those skilled in the art will recognize that the invention can be practiced with modification within the spirit and scope of the appended claims. For example, while a scenario has been discussed with various colored lights, obviously different colored lights could be used, as well as different formats for the lights (e.g., pulsing, flashing, etc.).

1. A warehousing system comprising:
a first container for storing at least one item of merchandise;
a first electronic module associated with said first container; and
a controller which wirelessly communicates with said first electronic module, for directing a transfer of said at least one item of merchandise to and from said first container.

2. The warehousing system according to claim 1, further comprising:
a second container for receiving said at least one item of merchandise from said first container,
wherein said controller directs a transfer of said at least one item of merchandise from said first container to said second container.

3. The warehousing system according to claim 2, wherein said second container is associated with a second electronic module which wirelessly communicates with said controller, for facilitating a transfer of said at least one item of merchandise from said first container to said second container.

4. The warehousing system according to claim 1, wherein said first electronic module comprises a light emitting device which is activated to indicate that said at least one item of merchandise should be transferred to and from said first container.

5. The warehousing system according to claim 1, wherein said first electronic module comprises a display device for indicating a content of said first container.

6. The warehousing system according to claim 1, wherein said first container comprises a plastic tote.

7. A hybrid retail/warehouse system comprising:
a retail/warehouse facility comprising a shelving area and a picking area adjacent to said shelving area, and having a layout so as to minimize a picking area and a walking distance between a picking area and a shelving area;
a container associated with said retail/warehouse facility for storing at least one item of merchandise,
an electronic module associated with said container; and
a controller which wirelessly communicates with said module, for directing a transfer of said at least one item of merchandise to and from said container,

8. The hybrid retail/warehouse system according to claim 7, wherein said merchandise is personally selected by in-store customers and remotely selected by out-of-store customers.

9. The warehousing system according to claim 7, wherein said electronic module is affixed to said container.

10. A warehousing method comprising:
storing at least one item of merchandise in a first container; and
remotely directing a transfer of said at least one item of merchandise to and from said first container, using a first electronic module which is associated with said first container.

11. The warehousing method according to claim 10, further comprising:
remotely assigning a second container to receive said at least one item of merchandise from said first container.

12. A hybrid retail/warehouse method comprising:
storing at least one item of merchandise in a container which is associated with a retail/warehouse facility, said facility comprising a shelving area and a picking area adjacent to said shelving area, and having a layout so as to minimize a picking area and a walking distance between a picking area and a shelving area; and
remotely directing a transfer of said at least one item of merchandise to and from said container, using an electronic module which is associated with said container.

13. The hybrid retail/warehouse method according to claim 12, wherein said merchandise is at least one of personally selected by in-store customers and remotely selected by out-of-store customers.

14. The hybrid retail/warehouse method according to claim 12, wherein said electronic module is affixed to said container.

15. The hybrid retail/warehouse method according to claim 12 wherein said container comprises a plastic tote.

16. A signal-bearing media tangibly embodying a program of machine-readable instructions executable by a digital data processor to perform a warehousing method, said method comprising:
storing at least one item of merchandise in a first container; and
remotely directing a transfer of said at least one item of merchandise to and from said first container, using an electronic module which is associated with said first container.

17. A signal-bearing media tangibly embodying a program of machine-readable instructions executable by a digital data processor to perform a hybrid retail/warehouse method, said method comprising:
storing at least one item of merchandise in a container which is associated with a retail/warehouse facility, said facility comprising a shelving area and a picking area adjacent to said shelving area, and having a layout so as to minimize a picking area and a walking distance between a picking area and a shelving area; and
remotely directing a transfer of said at least one item of merchandise to and from said container, using an electronic module which is associated with said container.

18. The warehousing system according to claim 1, wherein said container comprises a pallet.

19. The warehousing system according to claim 1, wherein said container comprises a plastic package.

20. The warehousing system according to claim 1, wherein said container stores one item of merchandise.

21. The warehousing system according to claim 1, wherein said controller wirelessly communicates with said first electronic module via a low frequency signal.

22. A pallet for storing an item of merchandise, said pallet comprising:
a body which contains said item of merchandise; and
an electronic identification module attached to said body.

23. A package for storing an item of merchandise, said package comprising:
a body which contains said item of merchandise; and
an electronic identification module attached to said body.

24. The warehousing system according to claim 1, wherein said first electronic module comprises an antenna for facilitating said communication with said controller.

25. The warehousing system according to claim 1, wherein said first electronic module is integrally formed with said first container.

26. A container for containing an item, comprising:
a body which contains said item; and
an electronic module integrally formed with said body.

27. The container according to claim 23, wherein said body comprises an antenna coupled to said electronic module for facilitating wireless communication with said electronic module.

28. The container according to claim 24, wherein said body comprises a plurality of sides, said antenna being integrally formed with at least one of said plurality of sides.

29. The container according to claim 24, wherein said antenna is integrally formed with said plurality of sides.

30. A package for containing an item, comprising:
a body which contains said item; and
an electronic module integrally formed with said body.

31. A pallet for containing an item, comprising:
a body which contains said item; and
an electronic module integrally formed with said body.
